(19) United States
(12) Patent Application Publication
(10) Pub. No.: US 2024/0023714 A1
(43) Pub. Date: Jan. 25, 2024

(54) ROTATIONAL SEATING

(71) Applicant: David Anthony Boeker, Springfield, LA (US)

(72) Inventor: David Anthony Boeker, Springfield, LA (US)

(21) Appl. No.: 17/814,137

(22) Filed: Jul. 21, 2022

(51) Int. Cl. A47C 3/18; A47C 1/00; A47C 3/16; A47C 7/02; A47C 7/62

(52) U.S. Cl. CPC A47C 3/18; A47C 1/00; A47C 3/16; A47C 7/029; A47C 7/622

(57) ABSTRACT

Rotational seating arrangements are disclosed relating to virtual reality and virtual reality gaming. Examples include a saddle suspended from a bearing by an arrangement of straps. Arrangements of these and other components are taught as allowing for a high degree of local mobility and as restricting undesirable movement of a user. Interactions of the user with the straps and the saddle are disclosed as allowing the saddle to follow a user through a wide range of motions staying continuously positioned as ready for immediate seating.

Rotational seating described herein may be used in virtual reality gaming. Certain saddle

suspension systems disclosed herein can accommodate a wide range of motions and postures while using virtual reality equipment and at the same time comfortably retain those motions within a space free of fragile and dangerous obstacles.

### BRIEF DESCRIPTION OF DRAWINGS

FIG. 1 depicts an elevation view of a saddle suspension system.

FIG. 2 depicts an elevation view of a saddle suspension system with the straps in an alternate position.

FIG. 3 depicts a perspective view of a saddle suspension system.

FIG. 4 depicts a plan view of a saddle overlaid with a depiction of the annular region.

### DETAILED DESCRIPTION

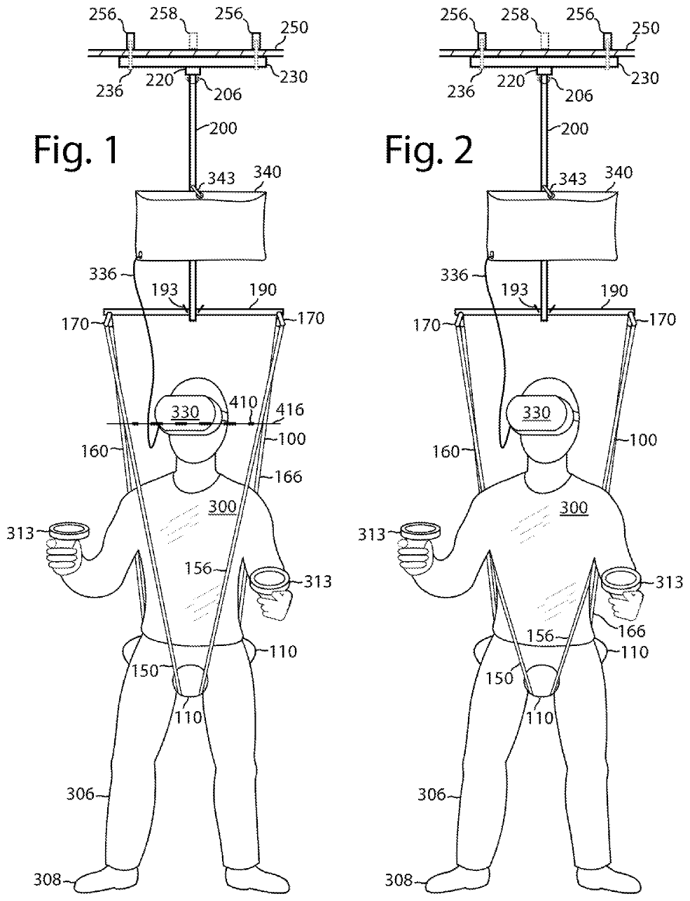

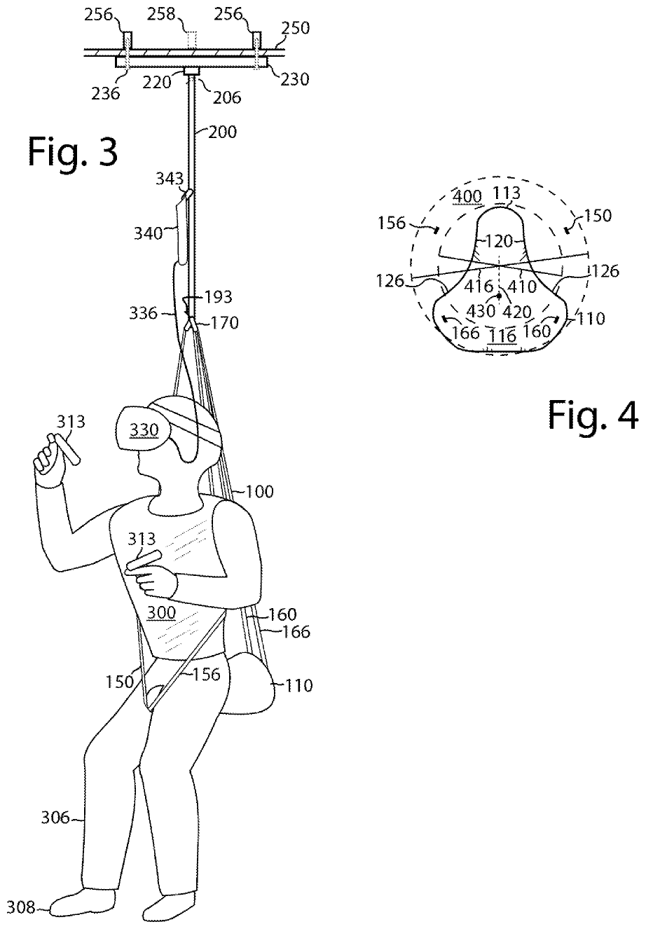

The saddle suspension system 100 depicted in FIGS. 1-4 may comprise a saddle 110 with a nose 113, a seat area 116, forward leg contact areas 120 and rearward leg contact areas 126, a front right strap 150, a front left strap 156, a rear right strap 160, a rear left strap 166, strap suspension clips 170, a crossbar 190, crossbar locking pins 193, a vertical bar 200, a vertical bar locking pin 206, a bearing 220, ceiling mounting plate 230, and fasteners 236 connecting the saddle suspension system 100 to ceiling 250 and joist pair 256 or alternatively connecting to single joist 258. A user 300 with pants 306 and footwear 308 may have controllers 313 and wear a virtual reality headset 330 which may have a wired connection 336 leading to a storage container 340 held by a container fastener 343.

The saddle suspension system 100 may have annular region 400 having an internal diameter 410 and an external diameter 416. Annular region 400 may be two-dimensional, positioned above the central axis 420 of the saddle, and positioned at a height 28 inches above the seat portion of the saddle. Annular region 400 may be centered on the rotational axis 430 of bearing 220 but may also be located above the front half saddle 110. In FIG. 4, only the portions of the straps passing through the annular region are shown.

The height at which the straps may attach to the crossbar or other structure may, for example, be 75.0 inches with certain examples falling between 70.0 and 115.0 inches and a significant number of those examples falling between 72.5 and 95.0 inches.

### Saddle

The configuration of the saddle, especially the space on either side of the saddle nose for the legs allows for the seat to reorient following the motion of the user to be in better alignment with the legs, buttocks, and waist of the user without conscious thought of the user.

When a standing user rotates their legs, buttocks, and waist together the saddle may rotate due to simultaneous pressure in the nose area of the saddle at the forward leg contact areas on one side and pressure on the rearward leg contact areas on the other side of the saddle causing a torque on the saddle which rotates the saddle in a way that corresponds to the motion of the legs, buttocks, and waist. The force of the legs directly on the saddle is one of two primary mechanisms by which the saddle maintains the correct rotational orientation relative to the body of the standing user. The other mechanism for maintaining the rotational orientation of the saddle relative to the standing user is the light pressure exerted on the straps by the torso. When the torso rotates the collective forces between the body and the straps creates a torque which tends to rotate the saddle in the direction of the rotation of the torso. While the rotational forces on the saddle caused by the straps and the pressure exerted by the legs may conflict with one another, such as when the body is twisting, the general collective action of those forces is to maintain the saddle in a rotational orientation ready for the user to sit at any time without adjustment of the saddle position by hand.

The position of the saddle is consistently maintained in an appropriate front to back position beneath the standing user by the forces of the body acting on the straps and the forces associated with the body's contact with the saddle. In particular, the legs of the user may prevent the saddle from moving too far forward and the forces of the standing body acting on the straps may prevent the saddle from moving either too far forward or too far to the rear.

When the user is sitting on the saddle the pressure of the user's body imparts additional torque on the seat portion of the saddle when the user's body rotates, and that sitting contact torque may become the primary force maintaining the orientation of the saddle relative to the user when the user is sitting.

When simulating running, limited movement of the legs back and forth adjacent to the nose of the saddle causes minimal disturbance or rotation to the saddle. The weight of the saddle and the shape of the saddle, particularly the nose of the saddle, may dictate the extent of rotation of the saddle created by a running motion with the legs.

Because the saddle is not attached to the floor and because it creates an open space under the user, leg motions of the user are not impaired in a manner typical of stools and chairs.

Because the saddle may be used in virtual reality applications where restraining the location of the user is desirable, the user may operate in the saddle with low traction footwear. This decreases the tendency for leg motions by the user to move the saddle. The low traction footwear may be socks and the surface that the footwear interacts with may be modified to enhance traction characteristics. For example, a carpeted surface may be replaced or covered with a lower friction platform like a rigid sheet of plastic or other suitable material.

Because the user is enabled to rotate freely and engage the floor with simulated running or walking motions in which the feet of the user slide along the floor rather than propelling the user forward, sensors may be utilized to track the simulated running, walking, and lower body motions. The tracking of those motions may be used as an input. For example, the lower body motion may be used as an input to a virtual reality game where the patterns of lower body motion impart motion to the character.

Similarly, the orientation of the saddle may be used as an input generally, and in particular as a game input. In certain cases, the orientation of the saddle may be used as an independent input to a game such that the independent motion of the saddle, a headset, and one or more controllers impart a more realistic game experience or impart a higher level of game control.

As used herein “saddle” designates a variety of types of seats having a forward protrusion that is arranged and configured such that the forward protrusion may be positioned between the legs of a user during use of the seat. Bicycle seats such as the Cruiser Bike Seat or Schwinn Cruiser Bike Saddle model number SW80337TG available from the Dorel Sports group of companies and Pacific Cycle, Inc., and saddle style seating furniture such as the DR. LOMILOMI massage supply Saddle Stool Seat available from https://www.drlomilomi.com/ at 15938 Downey Ave, Paramount, CA 90723 are instances of saddles as that term is used herein. Other types of seats including stools and chairs may be used as a substitute for the saddle when suspended using techniques described herein.

At any time, the user may lower their torso from a standing position and the saddle should be positioned below them oriented such that the user may sit directly in the saddle without repositioning the saddle relative to the user. When the user sits in the saddle the height of the saddle may be such that the user enters an athletic sitting position. The athletic sitting position is a position in which the knees of the user are slightly bent and in which the user may comfortably engage their feet with the floor in a variety of motions. The athletic sitting position has a knee bend more typical of the crouch of a base runner in baseball rather than the more common 90° angle associated with sitting in chairs. The leg angle formed by the knee in the sitting position in the saddle may be between 110 and 180° and in many cases that angle would be between 120° and 170°.

The saddle and all points of attachment from the saddle through to the ceiling may be designed to hold the full weight of a user and include a significant safety factor to ensure that the full body weight of the user may be suspended without damage to the equipment, building, user, or surroundings. Because the height of the top of the saddle may be only slightly below the standing inseam, the user may lift their feet off the floor and have substantial room for various leg motions, including simulated running in which the feet to do not contact the floor. As that phrase is used herein the “top of the saddle” and corresponding “top of the seat” designates the portion of the saddle or seat that a person's crotch inseam would contact and that would bear most of the weight of a sitting person. Those phrases should not be construed to include any chair back or other upward protruding structure that would not bear the weight of a person sitting upright.

### Straps

The straps may loop underneath the saddle so that a single piece may be used as two straps or individually attach to the saddle. For example, the back left strap may loop underneath the saddle reappearing as the front left strap. Similarly, the back right strap may loop underneath the saddle reappearing as the front right strap. The connected straps may cross over each other as well. The straps may be secured beneath the saddle either with a fixed-point attachment or an adjustable attachment allowing strap adjustment beneath the saddle. In cases where the saddle has a bottom plate, commonly used for attachment to lower stool components the straps may be run between the bottom plate and the saddle.

The saddle and strap configuration may be partly characterized by the lack of a need for a harness like restraint. For example, the body need not be securely attached to the suspension components. For example, there need not be a belt attached both to the user and the suspension components. Straps wrapping around the thighs are not necessary and straps securing the torso to the suspension components are not necessary.

The front straps are generally configured to pass in front of the lower portions of the torso of the user such that they are in front of the user at the belt level. The front straps may be positioned in front of the user at chest level, or they may wrap around the sides of the user so that the straps are positioned behind the shoulders of the user. The selection of where to orient the front straps relative to the upper torso of the user may be based on the preference or comfort of the user. Positioning the front straps behind the shoulders allows for a greater ability to lean forward and a greater ability to reach below the waistline.

The distance between the two front straps as measured on-center at the top of the saddle may, for example, be 5.3 inches with certain examples less than 10.0 inches and a significant number of those examples falling between 2.0 and 7.7 inches.

The distance between the two rear straps as measured on-center at the top of the saddle may, for example, be 6.8 inches with certain examples falling between 4.0 and 12.0 inches and a significant number of those examples falling between 5.4 and 9.4 inches.

The distance between the front and back straps as measured on-center along the center line of the saddle at the top of the saddle may, for example, be 13.8 inches with certain examples falling between 7.0 and 25.0 inches and a significant number of those examples falling between 10.4 and 19.4 inches. Note that this is a measure of the front to back separation that would not change for example if the back straps were moved to be further apart from one another.

The horizontal on-center separation of the left side straps from the right-side straps at the cross bar may, for example, be 18.3 inches with certain examples falling between 10.0 and inches and a significant number of those examples falling between 14.2 and 24.2 inches.

Any of the straps may be equipped with an adjustment mechanism for adjusting the length of the strap at a height that is within the reach of the user, such as a ladder lock tri-glide tension lock slide buckle, and may have quick release buckles.

In the place of straps; ropes, wires, and other tension bearing suspension apparatus may be used. These tension bearing suspension apparatus may be generically referred to herein as suspender(s).

The location of the points of attachment of the straps to the saddle and the points of attachment of the straps to the crossbar or other structure may be combined in a number of ways that maintain contact of some or all the straps with the body while allowing for a wide range of motion for the user's head and a virtual reality headset without the user's head or headset coming into contact with the straps. The wide range of potential configurations may be characterized by an annular area through which the straps pass.

Above the saddle the straps may pass through a horizontal annular area 28 inches above a top of the saddle with an annular area internal diameter of 12 inches and an annular area external diameter of 30 inches such that the horizontal annular area is centered above the saddle. The horizontal separation of the right side straps from the left side straps at the point of attachment to the crossbar may be 18.25 inches.

### Crossbar

The rigidity of the structure from which the straps hang may be such that the user can simulate running sliding their feet across the floor while creating less than 10° of rotation in the structure.

The crossbar or frame from which the straps hang and the components situated above may be configured to center the user and the saddle below the bearing. Components may be arranged, fitted, and joined to produce a rigid or relatively rigid rotating structure. The construction may substantially eliminate or significantly limit the horizontal motion of the bar or frame such that when the user engages in horizontal motion away from the position in which the saddle would freely hang without the user, the straps would act to both restrain further horizontal movement away from the free hanging position and gently urge the user back toward that position. The force of urging the user back to the free hanging position may be proportional to the degree of departure from the free hanging position. When the user sufficiently departs from the free hanging position of the saddle by a sufficient distance, the top height of the saddle will rise to an undesirable height as the saddle and straps engage in a pendulum type of motion. A sufficient rising height of the top of the saddle when the user is significantly out of the centered position may limit the mobility of the user. That decrease in mobility may take the form of decreased opportunity for motions associated with gameplay or physically stopping the user from further progressing away from the free hanging position. The varying levels of force returning the user to center, physical restraints, and freedom of motion encouragements act cooperatively as protections against damage commonly caused by users engaged in virtual reality activities, such as punching a television.

The saddle may be hung with a large number of structural substitutes for the crossbar. In particular, larger users may require or be more comfortable with hanging structures that have front to back depth such as the “X” configuration described above. The selection of the structure from which the straps hang to hold the saddle may be modified in various ways such that the straps interact with the user exerting a comfortable amount of pressure on the user.

The crossbar may fit within hole(s) drilled into the vertical bar and may be secured in place relative to the vertical bar by way of cotter pins fitted through holes in the crossbar at the vertical bar.

The broader surface of attachment of a ceiling mounting plate may reduce damage associated with direct attachment of the bearing to the ceiling. This may limit the impact of torquing forces on fasteners used to secure the saddle to the ceiling. A variety of fasteners may be used to secure the saddle and associated equipment to the structural components of the ceiling with the fastening techniques used being appropriate to the type of ceiling.

The ceiling mounting plate may take the form of a circular piece of wood bolted into the ceiling joist. Pieces of wood of various shapes and sizes or other materials may be used as the ceiling mounting plate and attachment may be to a single joist or multiple joists. In certain cases, the ceiling mounting plate may be omitted. Fasteners may take the form of bolts, screws, and any number of other fasteners appropriate for the type of ceiling to which the saddle is being attached.

Straps may be attached at the ends of the crossbar by hooks and holes or by other suitable means. The crossbar may be substituted for any other number of structures suitable for suspending the saddle and having the straps operate in a manner consistent with the descriptions above. For example, the crossbar may be replaced with a set of bars forming an “X” that is held in the middle by the vertical bar with the tip of each bar holding one of the straps.

In addition to standing on the saddle or sitting in the saddle, a user may stand leaning slightly backward in the saddle in a partially supported resting position comparable to sitting on/against the railing. In that case, the weight of the individual may be divided such that the saddle supports part of the user's weight and the user's legs support the remainder of the weight.

### Bearing

The bearing used for swiveling rotation may for example be a Seleware Heavy Duty Swing Hanger Bearing Swivel Hook, 360 Swivel Swing Hanger with Carabiner, Indoor Outdoor Swing Hardware for Tire Swing Kit Saucer Swing Playground Accessories Hammock Chair Swing available from Amazon https://www.amazon.com/dp/B0943PM936/ref=cm_sw_r_apa_i_E3Z0EXHMXON2SBMYH320_0?_encoding=UTF8&psc=1. The bearing may be any type of bearing suitable for 360° continuous rotation. The bearing may be more generally characterized as a swivel and nonbearing swivels may also be used including cloth, straps, rope, and other materials suitable for bearing the weight of the user through large numbers of rotations. When bearings or other elements not suitable for an infinite number of rotations are used, materials may be selected to limit the amount of torque applied to the user tending to oppose the rotation of the user. Material selection may be made to limit the unwinding effect on the user caused by the materials replacing the bearing.

The bearing may have a depending D-ring which fits snugly into the vertical bar which may be square tubing. In the case where the vertical bar is square tubing, a pin may run through the square tubing Walking the square tubing in place and tightly fitting the square tubing to the bearing. That fit may be such that it substantially limits any swing by the vertical bar below the bearing. In certain cases, the amount of swing of the vertical bar below the bearing may be less than 25° from vertical. In some cases, the amount of swing of the vertical bar below the bearing may be less than 10° from vertical.

The size of the bearing and the degree of structural support between the bearing and the straps control the degree of swing of the entire structure from which the straps hang. In certain cases, the amount of swing of the structural support between the bearing and the straps may be less than 25° from vertical. In some cases, the amount of swing of the structural support between the bearing and the straps may be less than 10° from vertical. Additional structure, increased bearing size, or both may be used to limit the motion of the saddle. However, cost constraints may limit such enhancements.

### Saddle Position

The height of the saddle may be adjusted such that the user is able to stand upright with their legs separated only by the width of the nose of the saddle. From a standing position the user can independently rotate their hips and torso with only light contact between the user and either the straps or the saddle. The pressure exerted by the limited contact of the straps and the saddle with the standing user may be less than half that of the pressure between the saddle and the user when the user rests their weight on the saddle. That light pressure allows the user to engage in an unlimited number of rotations in which the saddle and straps maintain their general orientation relative to the user rotating with the user. It is the rotation of the user that causes the rotation of the saddle and the straps.

As used herein, the phrase “standing inseam” is the distance between the crotch seam of the user's pants, shorts, or other apparel and the floor when standing straight up. As used herein, the phrase “crouching inseam” is the distance between the crotch seam of the user's pants, shorts, or other apparel and the floor when crouching. As used herein, the phrase “stance percent” is the crouching inseam divided by the standing inseam expressed as a percentage.

The saddle may be positioned relative to the user such that when sitting on the saddle with feet on the floor, the stance percent is greater than 75%. In certain cases, the saddle may be positioned relative to the user such that when sitting on the saddle with feet on the floor, the stance percent is greater than 85%.

The straps may be configured to alter the height and orientation of the saddle. The saddle may be positioned relative to the user such that when the user is standing with the nose of the saddle between the user's legs, the distance between the crotch seam of the user's pants, shorts, or other apparel and the saddle is less than 4.0 inches. In certain cases, the saddle may be positioned relative to the user such that when the user is standing with the nose of the saddle between the user's legs, the distance between the crotch seam of the user's pants, shorts, or other apparel and the saddle is between 0.3 inches and 2.5 inches. That distance may for example be 0.5 inches.

The nose angle may, for example, be 5.0° below level with certain examples falling between 20.0° above level and 30.0° below level and a significant number of those examples falling between 7.5° above level and 17.5° below level. Measurement of level for the saddle is according to standards of the International Cycling Union in place on Jan. 1, 2022.

The saddle configuration described herein allows for significant utilization of the arms legs and body of a user constraining the location and general activity of the user to a relatively small area. By doing so the user may avoid hitting walls and other objects while operating a virtual reality headset.

The saddle seat cushion and configuration of the straps provides a higher level of comfort and less localized pressure as compared to systems that utilize a full body harness. In particular, the saddle arrangement avoids straps that run along the inner thigh at or near the crotch.

The design of the saddle and associated components may allow the user to imitate running while remaining in one place to make a virtual reality Avatar run in virtual reality with the possible use of full body tracking and collision physics implemented into a game between the Avatar's feet and the virtual floor.

If someone needs to bend forward to pick up an in-game object in VR, the user may slide their arm and shoulder in front of the chest strap to bend down and pick up or touch an object in VR. While doing this the user can use their other hand or arm that's not bending down to pick up something to hold on to a chest strap to keep them from falling over. In cases where the user desires to move their upper body side to side and forward in a dodging manner, the user can have both chest straps slid behind the user's shoulders. If the user wants to sit in a crouching position bending their legs, they can adjust the straps height to lower the saddle seat allowing for that type of movement. The configuration of the saddle allows the saddle to follow a user through a wide range of motions staying continuously positioned as ready for immediate seating. The configuration of the saddle also allows the user to simulate many motions more typically associated with standing while the user sits or partially rests their weight on the saddle. Certain simulated movements including running, walking, jogging, pivoting, jumping, bending over in various directions, crouching, shuffling in various directions etc. may be performed while a user is resting more than half of their weight on the saddle or when they are resting all their weight on the saddle. The same motions may be simulated by the user while the user is resting less than half of their weight on the saddle or when the user is completely supporting their own weight.

### Accessories

A wire lock pin, hook, or similar attachment means may be used to hold the weight of a laptop, battery, or other equipment. Such equipment may be attached and stowed above the user, below the saddle, or at any other convenient location on the portion of the saddle, straps, and structure that rotates with the user so that the user has continuous access to that equipment without worry of cord entanglement or damage. Being able to spin 360° on the Saddle with the laptop strapped onto the saddle allows a user to attach a virtual reality headset link cable from the headset to the laptop which in turn allows the user to operate in virtual reality without the virtual reality link cable getting tangled around the user's legs. This can eliminating the problem of tripping over the cable which could damage the cable, the computer and the virtual reality headset. This configuration allows for all the necessary components associated with virtual reality to be incorporated into a single system with a high level of freedom of movement while minimizing concern over damage to the virtual reality equipment and other adjacent objects.

The headings used herein are for navigational and reference purposes only and not intended for use in interpretation.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application.

1. A seating arrangement comprising:
a. a saddle having a nose;
b. a first suspender attached to the nose;
c. a second suspender attached to the saddle on a seat area side of the saddle;
d. a structure having a first attachment point and a second attachment point; and
e. a swivel;
f. wherein the structure is configured to hang from the swivel;
g. wherein the first suspender is attached to the first attachment point; and
h. wherein the second suspender is attached to the second attachment point.

2. The seating arrangement of claim 1 further comprising a third suspender attached to the nose and a fourth suspender attached to the saddle on the seat area side of the saddle.

3. The seating arrangement of claim 1 wherein the swivel is a bearing.

4. The seating arrangement of claim 1 wherein the first suspender is a strap. The seating arrangement of claim 1 wherein the first suspender is adjustable.

6. The seating arrangement of claim 1 further comprising a container for a laptop computer wherein the container is arranged and configured to engage in a rotation pattern that follows a rotation pattern of the saddle.

7. The seating arrangement of claim 1 further comprising a ceiling mounting plate connected to the bearing.

8. The seating arrangement of claim 1 wherein each suspender attached to the saddle passes through a horizontal annular area 28 inches above a top of the saddle with an annular area internal diameter of 10 inches and an annular area external diameter of 55 inches.

9. The seating arrangement of claim 1 wherein each suspender attached to the saddle passes through a horizontal annular area 28 inches above a top of the saddle with an annular area internal diameter of 12 inches and an annular area external diameter of 30 inches.

10. The seating arrangement of claim 1 wherein each suspender attached to the saddle passes through a horizontal annular area 28 inches above a top of the saddle with an annular area internal diameter of 12 inches and an annular area external diameter of 30 inches and wherein the horizontal annular area is centered above the saddle.

11. A seating arrangement comprising:
a. a seat;
b. a first suspender attached to a central area of a front of the seat;
c. a second suspender attached to a rear portion of the seat;
d. a structure having a first attachment point and a second attachment point; and
e. a swivel;
f. wherein the structure is configured to hang from the swivel;
g. wherein the first suspender is attached to the first attachment point;
h. wherein the second suspender is attached to the second attachment point;
i. wherein the seat is configured for free rotation below the swivel; and
j. wherein the first suspender is arranged and configured to interact with a user of the seat causing the seat to rotate in response to the rotation of the user.

12. The seating arrangement of claim 11 further comprising a third suspender attached to the central area of the front of the seat and a fourth suspender attached to the rear portion of the seat.

13. The seating arrangement of claim 11 wherein the swivel is a bearing.

14. The seating arrangement of claim 11 wherein the first suspender is a strap.

15. The seating arrangement of claim 11 wherein the first suspender is adjustable.

16. The seating arrangement of claim 11 further comprising a container for a laptop computer wherein the container is arranged and configured to engage in a rotation pattern that follows a rotation pattern of the seat.

17. The seating arrangement of claim 11 further comprising a ceiling mounting plate connected to the bearing.

18. The seating arrangement of claim 11 wherein each suspender attached to the seat passes through a horizontal annular area 28 inches above a top of the seat with an annular area internal diameter of 10 inches and an annular area external diameter of 55 inches.

19. The seating arrangement of claim 11 wherein each suspender attached to the seat passes through a horizontal annular area 28 inches above a top of the seat with an annular area internal diameter of 12 inches and an annular area external diameter of 30 inches.

20. The seating arrangement of claim 11 wherein each suspender attached to the seat passes through a horizontal annular area 28 inches above a top of the seat with an annular area internal diameter of 12 inches and an annular area external diameter of 30 inches and wherein the horizontal annular area is centered above the seat.
